(19) United States
(12) Patent Application Publication
(10) Pub. No.: US 2003/0040926 A1
(43) Pub. Date: Feb. 27, 2003

(54) System and method for populating a region in a publication

(76) Inventor: John R. Milton, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 09/938,705

(22) Filed: Aug. 23, 2001

(51) Int. Cl. G06F 17/60

(52) U.S. Cl. 705/1

(57) ABSTRACT

A method, a program embodied on a computer readable medium, and a system for populating at least one region in a publication are provided. In one embodiment, the method includes the steps of associating a priority with each of a number of content items to be populated into the at least one region of the publication in a computer system, and, populating the at least one region with the content items in an order corresponding to the priority associated with each of the content items.

### TECHNICAL FIELD

The present invention is generally related to the field of digital publishing and, more particularly, is related to a system and method for populating an undefined region in a publication.

### BACKGROUND OF THE INVENTION

In the mid 1400's, Johann Gutenberg revolutionized how information is disseminated through his invention of the movable type press. With the publication of the Mazarin Bible, documents which were once held in the exclusive domain of a chosen few were now widely available to the masses. Nearly 550 years later, the mass media revolution that Gutenburg started is alive and well, complete with newspapers such as the New York Times and the Washington Post, magazines such as Newsweek and Sports Illustrated, and literally thousands upon thousands of other lesser known publications.

While these thousands of publications cover a wide range of interests, from news to sports to fashion to model rocketry, they have one thing in common in that they are intended to be read by a mass market. Unlike the pre-Gutenberg days, where a document would literally be read by only one person or a very small number of people, it is not economically viable for today's publications to have such a small readership, due at least in part to high marketing, production and distribution costs. In fact, many of today's publications are funded to a very large extent by the advertising contained within them. These advertisers are attracted to publications that can consistently deliver a large, reliable audience of consumers that will be exposed to their advertising.

While this mass market publication model has worked well for hundreds of years, it is not without its problems. One such problem is that a typical reader of a publication has a wide variety of interests, and no single mass market publication will be able to satisfy all these interests. For example, a reader who is interested in international news, golf, fly fishing, genealogy, and computers may have to subscribe to several different publications to satisfy these interests. Of course, since these publications are intended for a mass market, they will also contain a significant amount of material including articles, advertising, and other content that does not hold our reader's interest. Consequently, our reader will ignore such material and a significant amount of paper is wasted. Advertisers know this, and agree to pay considerably less to mass market magazine or newspaper per 1000 exposures to their ad than they would pay to a direct-mail generator that provides a more specific guarantee that the people exposed to their ad are of a demographic group that will be much more likely to read their ad and be interested in it.

In addition, it is neither cost-effective nor time effective for most readers to subscribe to and/or read a large number of publications. Generally, the typical reader will only subscribe to a few publications that are of the most interest to them. The reader reduced readership level of the publications our typical reader chooses not to subscribe to, even though he would be interested in at least some of the editorial and advertising content contained inside, means that the publication receives less subscription and advertising revenue than they otherwise would. If many other readers make the same decision, the continued health of the publication may be in jeopardy, and the publication may be forced to go out of business. In fact, many publications do go out of business yearly for failing to attract a sustaining number of advertisers and readers. This occurs even if there are a large number of readers that would be interested in reading their publication, and a corresponding number of advertisers anxious to have these readers exposed to their ads. In general, publications that fail to attract a substantial mass market of people willing to pay for and/or read them cease publication. This is a shame, since many of these publications would enrich the diversity of information available to all readers, and would provide an avenue for lesser known writers and artists to practice their wares.

In more recent years, a new type of publication has emerged, namely, the personalized publication. Readers of these publications typically sign onto the Internet through their computer or other network capable device, and read the publications online or have the publication downloaded and printed on a printer. These publications are “personalized” in that many allow readers to state personal preferences on what type of material they want to read.

Articles, advertising, and other content items are then included in the personalized publication, thus creating a publication that is of specific interest to a specific reader. Often, these personalized electronic publications include advertising in various locations.

A specific personalized publishing service can now generate thousands if not millions of personalized publications each day. In creating the personalized publications, on-line publishers are faced with the task of determining which articles or other content items are to be placed therein. Given the significant amount of content available, it may be quite difficult to accomplish this task in a manner that ensures that the content that is most relevant to an individual is included in the publication. This is especially the case when there is not enough space in the publication to include all of the content items that are identified as being of interest to a specific user.

### SUMMARY OF THE INVENTION

In light of the foregoing, the present invention provides for a method, a program embodied on a computer readable medium, and a system for populating at least one region in a publication. In one embodiment, the method includes the steps of associating a priority with each of a number of content items to be populated into the at least one region of the publication in a computer system, and, populating the at least one region with the content items in an order corresponding to the priority associated with each of the content items.

Other features and advantages of the present invention will become apparent to a person with ordinary skill in the art in view of the following drawings and detailed description. It is intended that all such additional features and advantages be included herein within the scope of the present invention.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a block of a publication distribution network according to an aspect of the present invention;

FIG. 2 is a block diagram of the operation of the publication distribution network of FIG. 1;

FIG. 3 is a drawing of a content item placed in a publication distributed via the publication distribution network of FIG. 1; and

FIG. 4 is a flow chart of a priority discriminator that is executed as part of a page layout engine in a publishing server in the publication distribution network of FIG. 1.

### DETAILED DESCRIPTION OF THE INVENTION

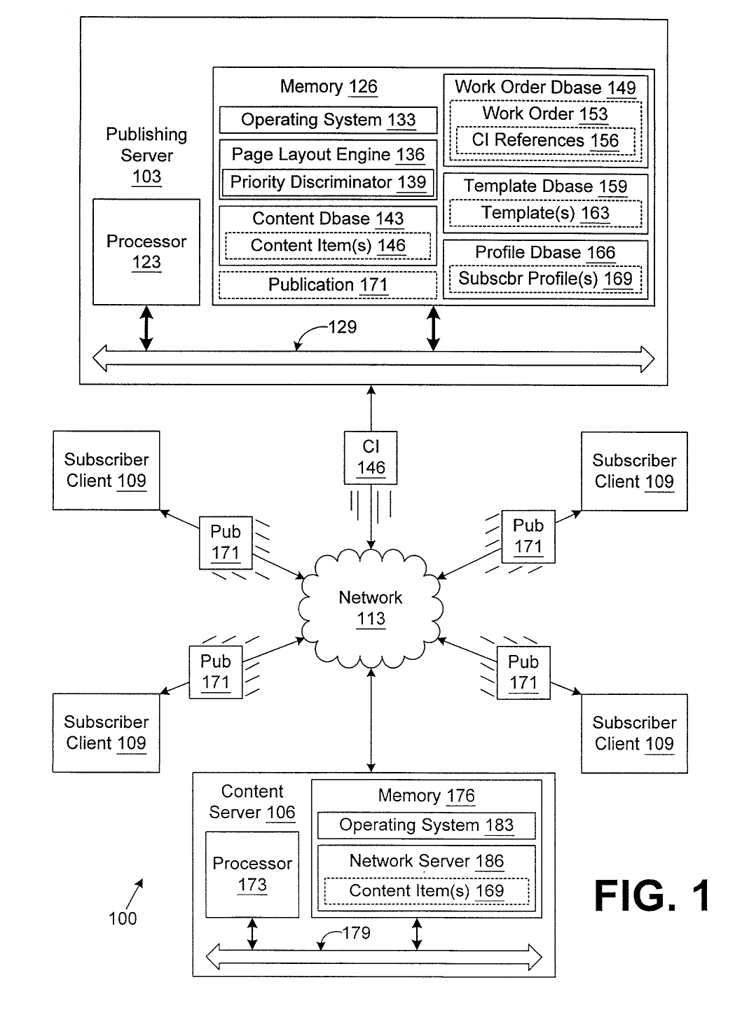

With reference to FIG. 1, shown is a publication distribution network 100 according to an aspect of the present invention. The publication distribution network 100 is employed to distribute a number of publications to a number of clients as will be described. In the discussion that follows, first a physical description of the publication distribution network 100 is provided followed by a description of the operation of the publication distribution network 100.

The publication distribution network 100 includes a publishing server 103, a content server 106, and one or more subscriber clients 109. The publishing server 103, content server 106, and subscriber clients 109 are all coupled to a network 113. The publishing server 103, content server 106, and one or more subscriber clients 109 may be, for example, computer systems or devices with like capability.

The network 113 may be, for example, the Internet, wide area networks (WANs), local area networks (LANs), wireless networks, or other suitable networks, etc., or any combination of two or more such networks. The publishing server 103, content server 106, and subscriber clients 109 are each coupled to the network 113 to facilitate data communication to and from other devices on the network 113. In this respect, the publishing server 103, content server 106, and subscriber clients 109 may be linked to the network 113 through various devices such as, for example, network cards, modems, routers, or other communications devices.

The publishing server 103 includes a processor circuit having a processor 123 and a memory 126, both of which are coupled to a local interface 129. The local interface 129 may comprise, for example, a data bus with an accompanying control/address bus as can be appreciated by those with ordinary skill in the art. Stored in the memory 126 and executable by the processor 123 are an operating system 133 and a page layout engine 136. The page layout engine 136 includes a priority discriminator 139. A more detailed description of the operation of these components will be provided in text that follows.

Also stored in the memory 126 and accessible by the processor 123 is a content database 143 having one or more content items 146, and a work order database 149 that includes one or more work orders 153. The content items 146 may be, for example, articles, photographs, pictures, advertisements, or other content that may be included in an online publication.

Each of the work orders 153 may include a content item reference 156. Also stored in the memory 126 is a template database 159 having a number of templates 163. The publishing server 103 also includes a profile database 166 stored in the memory 126 that contains a number of subscriber profiles 169. The subscriber profiles 169 include a number of interests of a particular subscriber that may be employed to identify content items 146 that the subscriber may be interested in reading or viewing as will be discussed.

A publication 171 is also stored in the memory 126 for a short period of time after it has been created before it is transmitted to a respective subscriber client 109. Ultimately, the publication 171 is created by the page layout engine 136 and includes a number of the content items 146 as will be discussed. The use of the various databases and items stored within each database will be described in later text.

The content server 106 also includes a processor circuit having a processor 173 and a memory 176, both of which are coupled to a local interface 179. The local interface 179 may be, for example, a data bus with an accompanying control/address bus as is generally known by those with ordinary skill in the art.

Stored on the memory 176 and executable by the processor 173 are an operating system 183 and a network server 186. Also stored on the network server 186 are content items 146 that may be served up to the publishing server 103 through the network 113. Specifically, the content server 106 may operate as a Hypertext Transfer Protocol (HTTP) server and the publishing server 103 may act as an HTTP client as can be appreciated by those with ordinary skill in the art. Also other protocols besides HTTP may be employed.

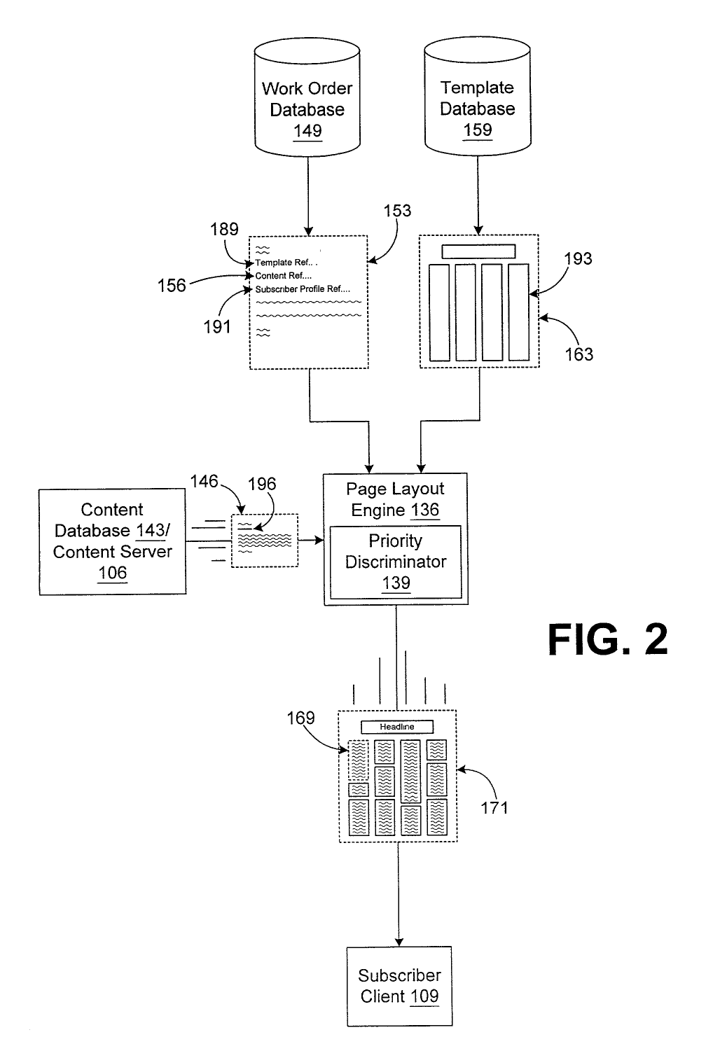

The publishing server 103 obtains the content items 146 from either the one or more content servers 106 on the network 113 or the content database 143 and generates the publication 171 therefrom. The newly generated publication 171 is then transmitted to one or more subscriber clients 109 via the network 113. A further description of the operation of the publication distribution network 100 is provided with reference to FIG. 2.

The publishing server 103, content server 106, and one or more subscriber clients 109 each may include various peripheral devices, such as, for example, a keyboard, keypad, touch pad, touch screen, microphone, scanner, mouse, joystick, or one or more push buttons, etc. Such peripheral devices may also include display devices, indicator lights, speakers, printers, etc. Specific display devices may be, for example, cathode ray tubes (CRTs), liquid crystal display screens, gas plasma-based flat panel displays, or other types of display devices, etc.

Each of the memories 126 and 176 may include both volatile and nonvolatile memory components. Volatile components are those that do not retain data values upon loss of power. Nonvolatile components are those that retain data upon a loss of power. Thus, each of the memories 126 and 176 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, each of the processors 123 and 173 may represent multiple processors and each of the memories 126 and 176 may represent multiple memories that operate in parallel processing circuits, respectively. In such a case, each of the local interfaces 129 and 179 may be an appropriate network that facilitates communication between any two of the multiple processors, between any processor and any of the memories, or between any two of the memories, etc. The processors 123 and 173 may be electrical or optical in nature.

The operating systems 133 and 183 are executed to control the allocation and usage of hardware resources in the publishing server 103 and the content server 106, respectively. Specifically, the operating systems 133 and 183 control the allocation and usage of processing time, any peripheral devices, and the memories 126/176, as well as performing other functionality. In this manner, the operating systems 133 and 183 serve as the foundation on which applications depend as is generally known by those with ordinary skill in the art.

While the content database 143, work order database 149, and the template database 159 are shown as stored in the memory 126 of the publishing server 103, it is understood that each of these databases 143/149/159 may be stored in other systems that are coupled to the network 113 and are accessible by the publishing server 103.

With reference to FIG. 2, shown is a block diagram that depicts the operation of the publication distribution network 100 (FIG. 1) in generating the publication 171. The following discussion also provides details as to use of prioritization in populating undefined regions in the publication 171 (FIG. 1). To begin, a work order 153 is obtained from the work order database 149. The work order 153 includes a number of content item references 156, a template reference 189, and a reader profile reference 191. The work order 153 may also include a number of content search parameters that correspond to the interests of a predetermined individual subscriber. Alternatively, the content search parameters may be stored in a separate database as a subscriber profile. If such were the case, the work order 153 would include a reference to the corresponding subscriber profile, thereby associating the interests of a specific subscriber with the work order 153.

Thus, the work order 153 generally contains the information needed to generate the publication 171. In this respect, the content item references 156 may be, for example, uniform resource indicators (URI) that point to a specific content item 146 stored in the content server 106. In this respect, the content item references 156 may be to one or more multiple content servers 106, wherever the content items 146 are stored. Alternatively, the content item references 156 may identify a content item 146 in the content database 143. The content item references 156 thus identify specific content items 146 to be employed in the respective publication 171. These content items 146 may be, for example, a periodic column, comic, or other repeated content.

The template reference 189 refers to a specific template 163 that is stored in the template database 159. The template 163 includes layout information that is to be employed to create the resulting publication 171. In particular, the template 163 includes one or more regions 193 into which content items 146 are populated. Thus, to create the publication 171, the page layout engine 136 “populates” the template 163 with the content items 146 referenced by the work order 153.

Although the work order 153 is shown as stored in the work order database 149, alternatively the work order 153 may be stored in a different device or computer system on the network 113 (FIG. 1). In such case, the work order 153 would be provided to the page layout engine 136 by the respective device. Note that the work order 153 may be applied to the page layout engine 136 according to a predefined schedule or upon request generated by one of the subscriber clients 109 as can be appreciated by those with ordinary skill in the art.

Once the page layout engine 136 obtains the work order 153, it proceeds to obtain content items 146 identified by the content item references 156, and the template 163 that is identified by the template reference 189. Also, the page layout engine 136 may obtain a subscriber profile 169 that is identified by the subscriber profile reference 191, if any, in the work order 153. The subscriber profile 169 includes various interests and other parameters associated with the respective subscriber. The page layout engine 136 employs these interests and other parameters to perform a search to obtain related content items 146 that align with the respective subscriber's interests or other information associated with the subscriber.

In any event, ultimately, the page layout engine 136 obtains a number of content items 146 to include in the respective publication 171 as well as a template 163 to be populated by the content items 146. Next the page layout engine 136 initiates the execution of the priority discriminator 139 in order to determine the order of placement of the content items 146 in the respective regions 193 of the template 163. This is done by assigning a priority to each of the content items 146 to be populated into the template 163.

The template 163 may include information regarding each of the regions 193. For example, some regions 193 are intended to be populated population by advertisements. Others may be designated for population with articles and still others pictures. Thus, the priority discriminator 139 may create several different content priorities among groupings of content items 146 that are associated with specific regions 193. To provide a specific example of the operation of the priority discriminator 139, the following discussion assumes that one or more regions 193 are to be populated by predetermined number of content items 146.

The priority discriminator 139 then associates a priority with each of the content items 146 to be placed in the respective region 193 of the template 163. The priority discriminator 139 may determine the priority associated with each of the content items 146 using one or more approaches or based on various criteria. For example, the interests or other parameters contained in the respective subscriber profile 169 may be employed to determine the priority that is to be associated with the respective content items 146. In particular, a higher priority is associated with content items 146 that provide content that is aligned more closely to the interests of the subscriber and vice versa. This may be determined, for example, by identifying the number of times various words are used in the content items 146 that describe a subscriber's predefined interests.

Other criteria or parameters that may be used to associate specific priorities to the content items 146 include examining the length of the content items 146 or determining a popularity of a specific content item 146 in terms of the number of times it was viewed by other subscribers. Also, a formula that takes multiple factors into account may be employed, etc.

Once a priority is associated with each of the content items 146, then the priority discriminator 139 determines whether a preference 196 is associated with any of the content items 146. A preference 196 is a predetermined value that is included in the content item 146 that is to be added or otherwise applied to a mathematical formula to alter a priority associated with the respective content item 146, thereby increasing the priority thereof. The preferences 196 may be employed, for example, as mechanism to generate revenue. For example, assume that the content items 146 are advertisements that compete against each other to be populated in the aforementioned at least one region 193. One advertiser may pay more to obtain a preference 196 that ensures that their advertisement will be used more frequently than advertisements of competitors.

Once the priorities associated with each of the content items 146 have been adjusted to reflect any preferences 196, then the content items 146 are populated into the template 163 in an order that corresponds to the priorities associated therewith. In some situations, some content items 146 may have the same priority associated therewith. Consequently, the priority discriminator 139 also determines which content item 146 is given priority over the other using one of a number of approaches. For example, assuming both were articles, then one may be populated before the other based on the alphabetical order of the names of the authors or the titles, etc. Alternatively, they may be populated in a random order or using another approach.

In some situations, it may be the case that the region 193 will not accommodate all of the available content items 146. In such case, the prioritization that is described herein ensures that the most relevant content items 146 that align with the reader's interests are used. The page layout engine 136 discards any such content items 146 that cannot be used in the resulting publication 171. Alternatively, the page layout engine 136 may shorten the content items 146 to fit within the region 193. For an example of a system that may be employed to shorten a content item 146 in this manner, reference is made to the United States Patent Application entitled “System and Method for Pruning an Article” filed on Dec. 15, 2000 and accorded Ser. No. 09/738,208, the entire content of which is incorporated herein by reference. After the publication 171 is created by populating the template with the content items 146, then it is transmitted to the appropriate subscriber client(s) 109.

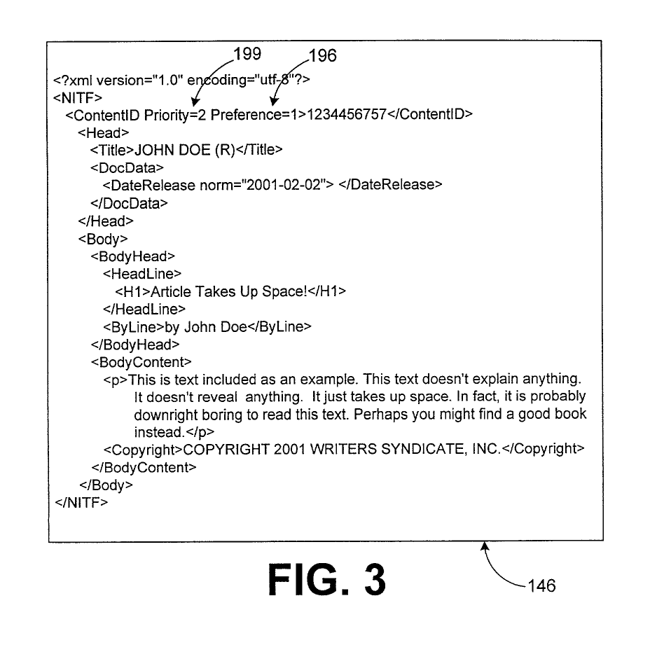

With respect to FIG. 3, shown is an example of a content item 146 according to an aspect of the present invention. The content item 146 may be expressed, for example, as an extensible mark-up language file (XML) according to a specific data type description (DTD). Specifically, the content item 146 is a text article that is expressed in a format similar to the News Industry Text Format (NITF). The NITF was developed by the International Press Telecommunications Council headquartered in the United Kingdom to define the content and structure of news articles and other content items 146. The content item 146 of FIG. 3 is thus provided as one example of the multiple different kinds of content items 146 that may be employed herein. For example, the content item 146 may also comprise, for example, an image or other content.

The content item 146 includes a preference 196 and a priority 199. As shown, the preference 196 and priority 199 may be expressed as attributes associated with the content item 146. In the example of FIG. 3, the preference 196 and priority 199 are expressed as attributes of a content identifier tag that designates an identifier that is unique to the content item 146. However, it is understood that the preference 196 and priority 199 may be expressed in some other manner. For example, the preference 196 and the priority 199 may be expressed in terms of tags themselves, etc.

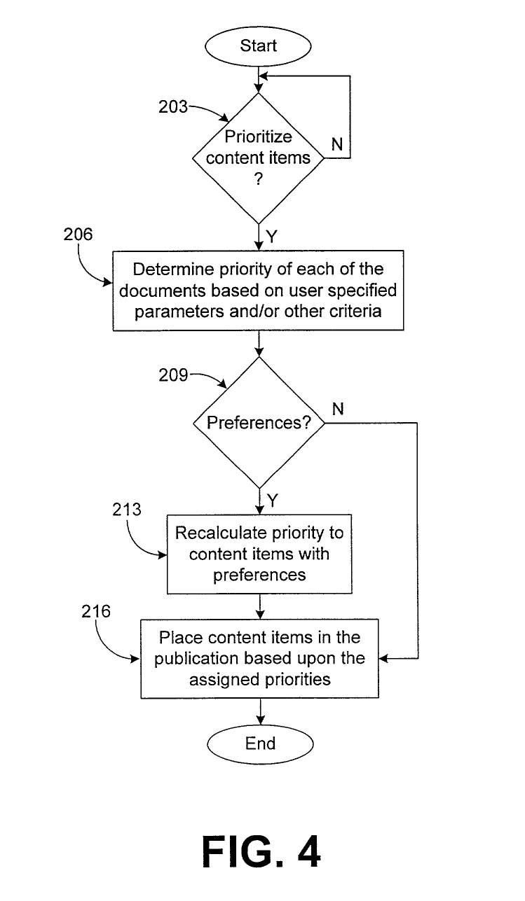

Turning then to FIG. 4, shown is a flow chart of the priority discriminator 139, according to an aspect of the present invention. Alternatively, the flow chart of FIG. 5 may be viewed as depicting steps in a method implemented in the publishing server 103 (FIG. 1) in prioritizing the content items 146 (FIG. 3) to be populated into the template 163 (FIG. 2).

Beginning with block 203, the priority discriminator 139 waits until there are a number of content items 146 to be prioritized to be populated into a template 163. In this respect, for example, the priority discriminator 139 may wait until called by the page layout engine 136 to perform the prioritization functions. In any event, once executed, the priority discriminator 139 then moves to box 206 in which an initial priority 199 (FIG. 3) is associated with each of the content items 146 based upon predetermined criteria. For example, a subscriber may cite several interests in their subscriber profile 169 (FIG. 1) that may be used to generate each priority 199. Specifically, the number of times the interests are mentioned in the text or title of the article may be employed to measure the relevance of a content item 146 to the interests of the subscriber. Other factors may be gauged to generate the initial priority 199. These may include, for example, the length or size of the content items 146 or user article preferences, etc. Also, the priorities may be generated using “article association” where one or more various articles are identified that are similar in subject matter to a particular article that is of particular interest to a subscriber. Also, other factors or criteria may be employed as discussed previously, etc. In associating the priority 199 with the respective content items 146, the priority 199 may be added to the content items 146 as an attribute or as a tagged item, etc.

Once a priority 199 is associated with each of the content items 146, then the priority discriminator 139 proceeds to box 209 in which it is determined whether there are any preferences 196 associated with any of the content items 146. This may be done by identifying a preference tag or attribute in the content items 146. In this regard, the priority discriminator 139 performs a search through all of the content items 146 to find any preference 196 associated with the respective content items 146. If preferences 196 are found, then the priority discriminator 139 proceeds directly to box 213. Otherwise, the priority discriminator 139 skips to box 216. In box 139, the priorities 199 of those content items 146 with an associated preference 196 are adjusted accordingly. Then, the priority discriminator 139 proceeds to block 216 in which the region(s) 193 in the template 163 are populated with the content items 146 in an order corresponding to the priorities 199 associated with the content items 146. Thereafter, priority discriminator 139 ends as shown.

Although the priority discriminator 139 of the present invention is embodied in software or code executed by general purpose hardware as discussed above, as an alternative the priority discriminator 139 may also be embodied in dedicated hardware or a combination of software/general purpose hardware and dedicated hardware. If embodied in dedicated hardware, the priority discriminator 139 can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow chart of FIG. 4 shows the architecture, functionality, and operation of an implementation of the priority discriminator 139. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flow chart of FIG. 4 shows a specific order of execution, it is understood that the order of execution may differ from that which is depicted. For example, the order of execution of two or more blocks may be scrambled relative to the order shown. Also, two or more blocks shown in succession in FIG. 4 may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present invention. Also, the flow chart of FIG. 4 is relatively self-explanatory and is understood by those with ordinary skill in the art to the extent that software and/or hardware can be created by one with ordinary skill in the art to carry out the various logical functions as described herein.

Also, where the priority discriminator 139 comprises software or code, it can be embodied in any computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present invention, a “computer-readable medium” can be any medium that can contain, store, or maintain the priority discriminator 139 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, or compact discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Although the invention is shown and described with respect to certain preferred embodiments, it is obvious that equivalents and modifications will occur to others skilled in the art upon the reading and understanding of the specification. The present invention includes all such equivalents and modifications, and is limited only by the scope of the claims.

I/We claim:

1. A method for populating at least one region in a publication, comprising:
associating a priority with each of a number of content items to be populated into the at least one region of the publication in a computer system; and
populating the at least one region with the content items in an order corresponding to the priority associated with each of the content items.

2. The method of claim 1, further comprising identifying the number of content items with which to populate the at least one region of the publication.

3. The method of claim 1, further comprising discarding select ones of the content items that do not fit within a remaining unpopulated portion of the at least one region.

4. The method of claim 1, further comprising shortening select ones of the content items that do not fit within a remaining unpopulated portion of the at least one region.

5. The method of claim 1, further comprising resolving a priority conflict between at least two of the content items having a same priority associated therewith.

6. The method of claim 1, further comprising:
identifying a preference associated with select ones of the content items; and
adjusting the priority associated with the select ones of the content items based upon the preference.

7. The method of claim 1, wherein the step of populating the at least one region with the content items in the order corresponding to the priority associated with each of the content items further comprises specifying the order to be from a highest priority to a lowest priority.

8. The method of claim 2, wherein the step of identifying the number of content items with which to populate the at least one region of the publication further comprises identifying the content items based upon a predefined criteria provided by a user.

9. A program embodied in a computer readable medium for populating at least one region in a publication, comprising:
code that associates a priority with each of a number of content items to be populated into the at least one region of the publication; and
code that populates the at least one region with the content items in an order corresponding to the priority associated with each of the content items.

10. The program embodied in a computer readable medium of claim 9, further comprising code that identifies the number of content items with which to populate the at least one region of the publication.

11. The program embodied in a computer readable medium of claim 9, further comprising code that discards select ones of the content items that do not fit within a remaining unpopulated portion of the at least one region.

12. The program embodied in a computer readable medium of claim 9, further comprising code that shortens select ones of the content items that do not fit within a remaining unpopulated portion of the at least one region.

13. The program embodied in a computer readable medium of claim 9, further comprising code that resolves a priority conflict between at least two of the content items having a same priority associated therewith.

14. The program embodied in a computer readable medium of claim 9, further comprising:
code that identifies a preference associated with select ones of the content items; and
code that adjusts the priority associated with the select ones of the content items based upon the preference.

15. The program embodied in a computer readable medium of claim 9, wherein the code that populates the at least one region with the content items in the order corresponding to the priority associated with each of the content items further comprises code that specifies the order to be from a highest priority to a lowest priority.

16. The program embodied in a computer readable medium of claim 1 0, wherein the code that identifies the number of content items with which to populate the at least one region of the publication further comprises code that identifies the content items based upon a predefined criteria provided by a user.

17. A system for populating at least one region in a publication, comprising:
means for associating a priority with each of a number of content items to be populated into the at least one region of the publication; and
means for populating the at least one region with the content items in an order corresponding to the priority associated with each of the content items.

18. The system of claim 17, further comprising means for identifying the number of content items with which to populate the at least one region of the publication.

19. The system of claim 17, further comprising means for discarding select ones of the content items that do not fit within a remaining unpopulated portion of the at least one region.

20. The system of claim 17, further comprising means for resolving a priority conflict between at least two of the content items having a same priority associated therewith.

21. The system of claim 17, further comprising:
means for identifying a preference associated with select ones of the content items; and
means for adjusting the priority associated with the select ones of the content items based upon the preference.

22. A method for populating at least one region in a publication, comprising:
identifying a number of content items with which to populate the at least one region of the publication in a computer system;
associating a priority with each of the content items;
identifying a preference associated with select ones of the content items;
adjusting the priority associated with the select ones of the content items based upon the respective preferences;
populating the at least one region with the content items in an order corresponding to the priority associated with each of the content items; and
discarding select ones of the content items that do not fit within a remaining unpopulated portion of the at least one region.

23. A system for populating at least one region in a publication, comprising:
means for identifying a number of content items with which to populate the at least one region of the publication in a computer system;
means for associating a priority with each of the content items;
means for identifying a preference associated with select ones of the content items;
means for adjusting the priority associated with the select ones of the content items based upon the respective preferences;
means for populating the at least one region with the content items in an order corresponding to the priority associated with each of the content items; and
means for discarding select ones of the content items that do not fit within a remaining unpopulated portion of the at least one region.
